(19) United States
(12) Patent Application Publication
(10) Pub. No.: US 2026/0261801 A1
(43) Pub. Date: Sep. 3, 2026

(54) ELECTROMAGNET FIELD RECEIVING AND PROCESSING SYSTEM

(71) Applicant: Studios Fierra LLC, Los Angeles, CA (US)

(72) Inventors: Alexandra Fierra, Los Angeles, CA (US); Bryn Nieboer, Los Angeles, CA (US)

(21) Appl. No.: 19/066,667

(22) Filed: Feb. 28, 2025

(51) Int. Cl. H04R 3/12; H04R 1/02

(52) U.S. Cl. CPC H04R 3/12; H04R 1/02; H04R 2430/01

(57) ABSTRACT

An electromagnetic field (EMF) receiver that outputs one or more audio signals corresponding received EMF energy. The EMF receiver includes one or more receiving channels, each including one or more EMF energy receiving elements. The elements may include inductors that induce currents that correspond to the received EMF energy. The receiving channels are physically offset from one another along the X-, Y-, and/or Z-planes, as are the receiving elements within each channel. In this way, energy received by the different channels and elements are inherently out of phase with one another, thereby producing desirable audio effects. The audio signals may be provided to a speaker and/or to signal outputs, and/or may be combined with auxiliary signals.

### FIELD OF THE INVENTION

This invention relates to receivers, including an electromagnetic field receiving and processing system.

### BACKGROUND

Electromagnetic field (EMF) energy is ever present generally everywhere. Such energy is produced by natural phenomenon (e.g., lightning) as well as by man-made appliances including lighting fixtures, motors, electronic equipment, etc.

However, state-of-the-art EMF receivers that may be designed to receive such EMF energy typically do little in the way of processing and providing audio output signals that correspond to the EMF energy. In addition, such receivers do not provide audio effects that may be applied to such audio output signals.

Accordingly, there is a need for an EMF receiving and processing system that receives EMF waveforms, and that processes such waveforms into audio signals. There also is a need for such a system that provides audio effects to the audio signals.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a block diagram of an electromagnetic field (EMF) receiver and processing system according to exemplary embodiments hereof;

FIG. 2 shows a representation of an EMF waveform;

FIG. 3 shows a block diagram of three receiving channels according to exemplary embodiments hereof;

FIG. 4 shows a layout according to exemplary embodiments hereof;

FIG. 5 shows aspects of three receiving channels according to exemplary embodiments hereof;

FIG. 6 shows a representation of a receiving channel and an EMF waveform according to exemplary embodiments hereof; and

FIGS. 7, 8, and 9 show aspects of an EMF receiver and processing system according to exemplary embodiments hereof.

### DETAILED DESCRIPTION OF EXEMPLARY EMBODIMENTS

In general, the system according to exemplary embodiments hereof includes an electromagnetic field (EMF) receiver and processing system.

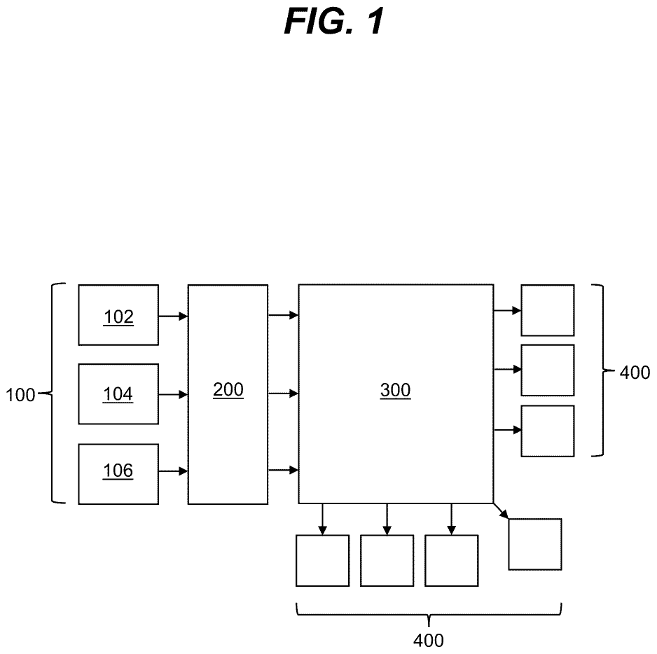

In some embodiments, as shown in FIG. 1, the electromagnetic field (EMF) receiver and processing system 10 (also referred to herein as simply the system 10) includes one or more receiver channels 100, an analog to digital converter (ADC) system 200, a digital signal processor (DSP) system 300, a signal input-output assembly 400, and a housing assembly 500. In general, the one or more receiver channels 100 are arranged in a novel configuration to each receive electromagnetic field (EMF) energy (e.g., from the surrounding environment) as analog signals. These received analog signals are provided to the ADC system 200 and converted into digital signals that are then provided to the DSP system 300 for processing. The digital signals are converted into audio signals and processed using one or more effects. The audio signals are then made available to one or more speakers and/or outputs via the signal input-output assembly 400. The system 10 and its various systems and elements are housed within the housing assembly 500. The system 10 also may include other elements as necessary for the system 10 to perform its functionalities.

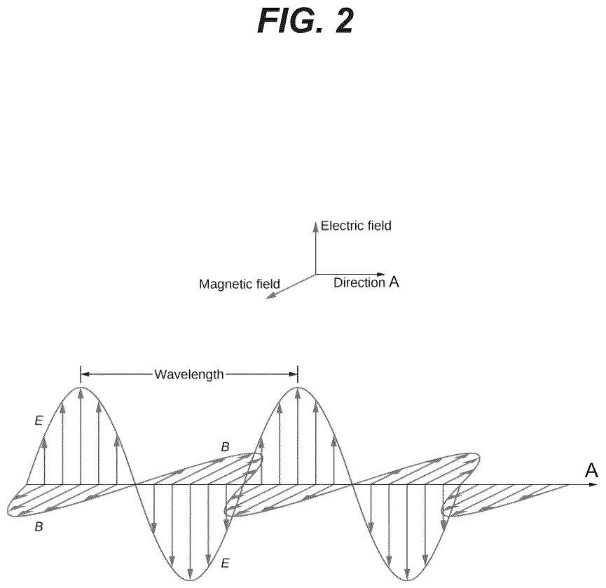

For discussion purposes, FIG. 2 shows a graphical representation of an electromagnetic waveform traveling through space in the direction A. As is known, electromagnetic fields comprise a physical field that represents the effects of electrical charges in space and time. As shown, the electromagnetic waveform comprises an electric field E and a magnetic field B, wherein the electric field E and the magnetic field B are perpendicular with one another and in phase. As such, the amplitude and phase of the energy of the electric field E and of the magnetic field B each vary depending on the location (e.g., in the X-, Y-, and Z-planes) and time.

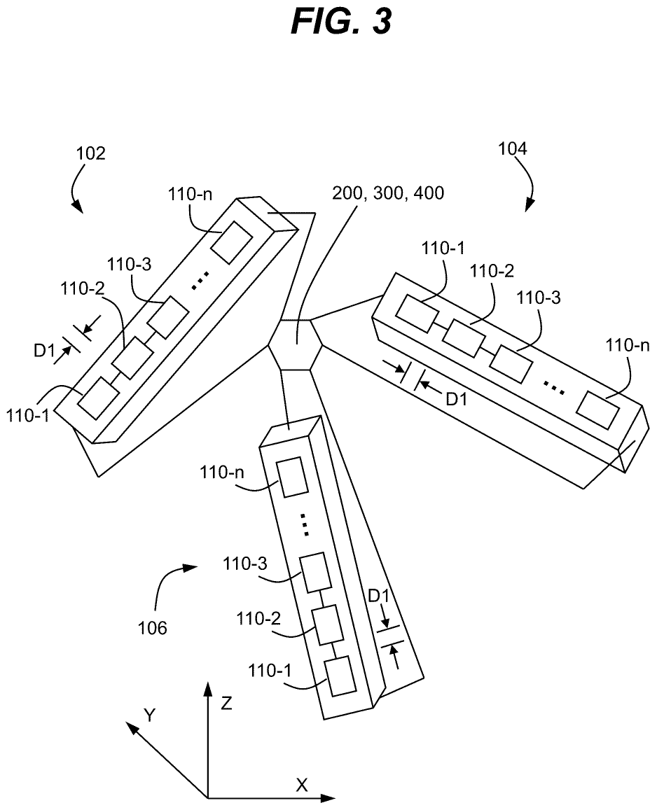

In some embodiments, the EMF receiver and processing system 10 may include one or more separate and distinct receiver channels 100. For example, as shown in FIG. 3, the system 10 may include a first receiver channel 102, a second receiver channel 104, and a third receiver channel 104. FIG. 3 shows the three separate and distinct receiver channels 102, 104, 106 as blocks for demonstration. The other elements of the system 10 (e.g., 200, 300, 400) have been combined into a single block for clarity. Each receiver channel 102, 104, 106 may include one or more mechanisms designed to convert electromagnetic energy into corresponding voltages and/or currents. Such mechanisms may include antennas, coils, and other suitable mechanisms. In general, each receiver channel 100 may include a structure (e.g., a circuit board or portion thereof, bracket, platform, and/or other suitable structure(s)) that includes an arrangement of such electromagnetic energy receivers and converters. In this way, each receiver channel 100 may be placed in a specific physical position and/or orientation within the system 10. For example, as will be described in other sections, the first, second, and third receiver channels 102, 104, 106 may be physically arranged in specific positions and/or orientations with respect to one another within the system 10.

In some embodiments, each receiver channel 102, 104, 106 may include one or more EMF receiver elements 108 designed to receive EMF energy. In some embodiments, the EMF receiver elements 108 may include electronic components such as inductors 110-1, 110-2, 110-3, . . . 110-n (individually and collectively 110) that may transform EMF energy into voltages and/or currents. The inductors 110 may induce an electric current when exposed to a changing EMF energy. This phenomenon may be referred to as electromagnetic induction. In some embodiments, the induced current from the inductors 110 may then be provided to the analog to digital converter (ADC) system 200 and to the digital signal processor (DSP) system 300 for processing as described in other sections.

It is understood that other types of EMF receiver elements 108 also may be used and that the scope of the system 10 is not limited in any way by the type(s) of receiver elements 108 that it may implement. In addition, while three separate and distinct receiver channel 102, 104, 106 are depicted, it is understood that any number of separate and distinct receiver channels may be utilized.

In some embodiments, the inductors 110 within each receiving channel 102, 104, 106 are arranged in series within the respective channel. In this way, electromagnetic energy received and induced into current by each inductor 110 may add to the current induced by the prior inductor(s) 110. As such, a total summation of induced current from the total inductors 110 within each receiving channel 102, 104, 106 may be made available by each individual channel 102, 104, 106 to the ADC system 200 and DSP system 300.

In some embodiments, as shown in FIG. 3, each sequential inductor 110 within each receiver channel element 102, 104, 106 is physically offset from its preceding inductor 110 and from its succeeding inductor 110 by a predetermined physical distance D1. As such, a first inductor 110-1 in a receiver channel 110 may receive a different portion of a particular EMF waveform incident onto the receiver channel 110 compared to a different inductor 110-n in the same receiving channel 110. As such, at any given moment in time, the amplitude and phase of the particular EMF waveform received by the first inductor 110-1 will be offset from the amplitude and phase of the same particular EMF waveform received by a different inductor 110-n. Given this, the induced currents from each respective inductor 110 also will be offset from one another. The induced currents from each respective inductor 110 within the series of inductors 110 making up a respective receiving channel 100 may then be added in series and provided to the ADC system 200.

In addition, when multiple EMF waveforms are present, traveling in varying directions and frequencies simultaneously, the offset inductors 110 within each receiving channel 100 may receive different portions of each of the multiple EMF waveforms, thereby inducing different offset currents corresponding to each different EMF waveform. Then, all of the induced currents from all of the incident EMF waveforms may be added to one another in series and provided to the ADC system 200. This out of phase relationship between the inductors 110 within each respective receiving channel 100 may cause a first inherent effect that may be provided by the system 10.

In addition, in some embodiments, as shown in FIG. 3, the receiver channels 102, 104, 106 themselves may be physically offset from one another along the X-plane, along the Y-plane, and/or along the Z-plane. As such, each receiving channel 100 may engage a different portion of each of the multiple EMF waveforms at different locations and at different orientations simultaneously compared to the other receiving channels 100. Given this, the currents induced in each receiving channel 100 are fundamentally offset and out of phase with respect to the currents induced in each other receiving channel(s) 100. This out of phase relationship between the receiving channels 102, 104, 106 may cause a second inherent effect that may be provided by the system 10.

Given the above, it is seen that the EMF receiver and processing system 10 may include physically offset receiving channels 100, with each offset receiving channel 100 including a plurality of physically offset EMF receiver elements 108, e.g., physically offset inductors 110.

In some embodiments, each receiving channel 102, 104, 106 provides its aggregate induced currents from its aggregate offset inductors 110 to a corresponding channel of the ADC system 200. In this way, the ADC system 200 may receive an independent and separate induced current waveform from each one of the receiving channels 102, 104, 106. It is understood that the number of independent and separate induced current waveforms that may be provided to and received by the ADC system 200 may preferably equal the number of independent receiving channels 100. In this example, because there are three independent receiving channels 102, 104, 106, the ADC system 200 may receive three independent and separate induced current waveforms, one from each channel 102, 104, 106. However, it is understood that the system 10 may include other numbers of receiving channels 100 such that ADC system 200 may receive an equivalent number of separate induced current waveforms.

In some embodiments, the ADC system 200 may process the separate induced current waveforms individually, e.g., convert the analog induced current waveforms into an equivalent digital signal that may then be provided to the DSP system 300 for further processing. This will be described in other sections.

It is understood that any of the induced current values (amplitude and phase) may be converted into corresponding induced voltage values (amplitude and phase) at any time or location within the system 10, and that any element within the system 10 may be configured to operate on induced current values and/or on induced voltage values.

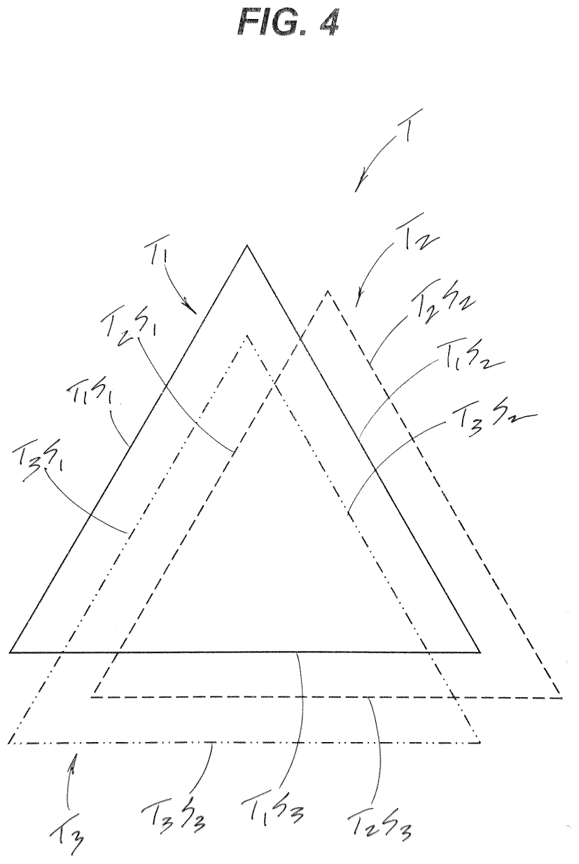

FIG. 4 shows a representation of an inventive receiver channel 100 geometry and/or layout of the EMF receiver and processing system 10. The layout shows three triangles T1, T2, and T3. Each triangle includes a first side (or leg) S1, a second side (or leg) S2, and a third side (or leg) S3. As such, the first triangle T1 includes a first side (or leg) T1S1, a second side (or leg) T1S2, and a third side (or leg) T1S3. Similarly, the second triangle T2 includes a first side (or leg) T2S1, a second side (or leg) T2S2, and a third side (or leg) T2S3, and the third triangle T3 includes a first side (or leg) T3S1, a second side (or leg) T3S2, and a third side (or leg) T3S3.

In some embodiments, the combination of triangles T1, T2, T3 arranged as shown in FIG. 4 form an overall triangular shape T, with the first triangle first side T1S1 generally forming the left side of the overall triangular shape T, the second triangle second side T2S2 generally forming the right side of the overall triangular shape T, and the third triangle third side T3S3 forming the bottom side of the overall triangular shape T. In addition, the first triangle second side T1S2 forms an interior left side of the overall triangular shape T interior and generally parallel to the second triangle second side T2S2, the second triangle third side T2S3 forms an interior bottom side of the overall triangular shape T interior and generally parallel to the third triangle third side T3S3, and the third triangle first side T3S1 forms an interior left side of the overall triangular shape T interior and generally parallel to the first triangle first side T1S1. It is understood that other overall shapes also are contemplated in addition to, in combination with, and/or instead of the overall triangular shape T, such as, without limitation, trapezoidal, pyramid-shaped, polygonal, other geometrical shapes, and any combinations thereof.

In some embodiments, the inventor has discovered that forming each receiving channel 100 as a portion of one of the respective triangles shown in FIG. 4, that the induced currents within each receiving channel 100, when processed alone and/or in combination with the induced currents of the other receiving channels, may create a desirable system output (e.g., when provided by the signal output assembly 400). The output will be described in other sections.

For example, in some embodiments, the first receiving channel 102 may be generally formed as the first triangle first and second sides T1S1, T1S2, the second receiving channel 104 may be generally formed as the second triangle second and third sides T2S2, T2S3, and the third receiving channel 106 may be generally formed as the third triangle third and first sides T3S3, T3S1. As described below, the receiving elements 108 (e.g., the inductors 110) of each respective receiving channel 102, 104, 106 may then be arranged in series along the respective sides of the triangles to form the receiving channels 102, 104, 106.

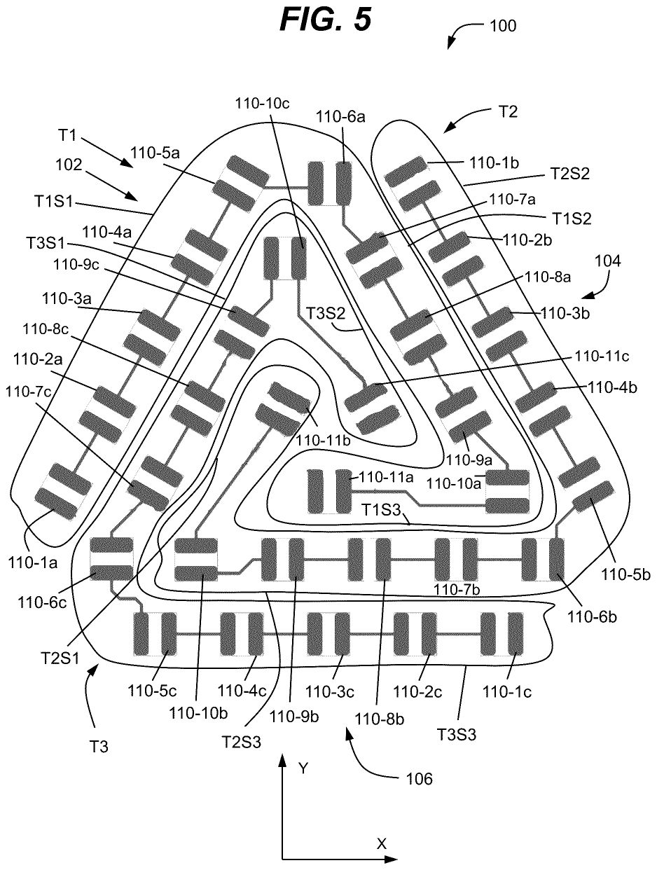

FIG. 5 shows an implementation of the above-described triangular arrangement of receiving channels 102, 104, 106. As shown, receiving channel 102 includes the first triangle first and second sides T1S1, T1S2, the receiving channel 104 includes the second triangle second and third sides T2S2, T2S3, and the receiving channel 106 includes the third triangle third and first sides T3S3, T3S1.

In addition, in some embodiments, the first receiving channel's 102's first side T1S1 is populated with series offset inductors 110-1a, 110-2a, 110-3a, 110-4a, and 110-5a, and its second side T1S2 is populated with series offset inductors 110-6a, 110-7a, 110-8a, 110-9a, and 110-10a. The first receiving channel 102 also may include an inductor 110-11a positioned in an interior center portion of the overall triangular shape T. Similarly, the second receiving channel's 104's second side T2S2 is populated with series offset inductors 110-1b, 110-2b, 110-3b, 110-4b, and 110-5b, and its third side T2S3 is populated with series offset inductors 110-6b, 110-7b, 110-8b, 110-9b, and 110-10b. Additionally, the third receiving channel's 106's third side T3S3 is populated with series offset inductors 110-1c, 110-2c, 110-3c, 110-4c, and 110-5c, and its first side T3S1 is populated with series offset inductors 110-6c, 110-7c, 110-8c, 110-9c, and 110-10c. The second and third receiving channels 104, 106 also may include offset inductors 110-11b, 110-11c, respectively, each positioned in an interior center portion of the overall triangular shape T. This architecture may be referred to herein as a 5-5-1 layout wherein a first set of five inductors 110 of each receiving channel 100 are positioned on an exterior side of the triangular shape T, a second set of five inductors 110 of each receiving channel 100 are positioned on the interior of an adjacent side (e.g., clockwise from the exterior side with the first set of inductors 110), and one inductor 110 positioned generally in the center portion of the triangular shape T.

In some embodiments, the first receiving channel's first and eleventh inductors 110-1a, 110-11a may provide the first and last element 108 of the series of inductors 110 for the channel 102, respectively, and as such, may each be electrically configured with the ADC system 200 and DSP system 300 to complete the series circuit. Similarly, the first and last inductors 110-1b, 110-11b, respectively, of the second receiving channel 104 may be electrically configured with the ADC system 200 and DSP system 300 to complete its series circuit, and the first and eleventh inductors 110-1c, 110-11c, respectively, may be electrically configured with the ADC system 200 and DSP system 300 to complete its series circuit. In this way, electrical currents induced by the inductors 110 within each receiving channel 102, 104, 106 may be provided to the ADC system 200 and DSP system 300 for processing.

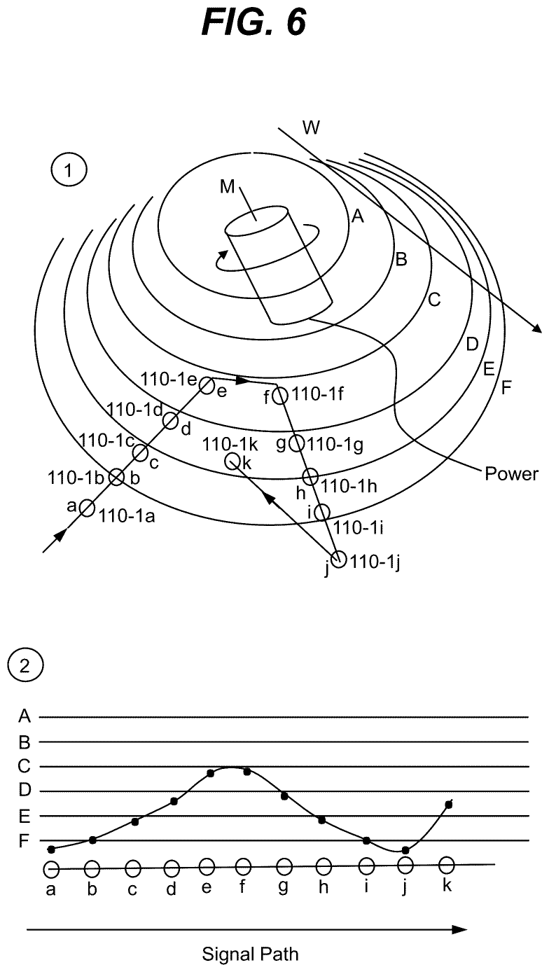

FIG. 6, image (1), shows a conceptual representation of a single receiving channel 100 (e.g., channel 102) with the geometry of FIG. 5 engaging with an EMF waveform W produced from an electric motor M. As represented by the concentric circles A, B, C, D, E, F, the electric motor M produces an EMF waveform W that radiates downward and outward, varying in amplitude and phase in three-dimensional space and time. The placement and orientation of the receiving channel 102 with respect to the motor M and the generated EMF waveform W is arbitrary and is meant for demonstration.

As shown, the receiving channel's first inductor 110-1a may lie outside the path of the waveform W and may receive negligible energy while the second inductor 110-1b may engage with the amplitude and phase of the waveform W at F. Similarly, the third inductor 110-1c may engage with the amplitude and phase of the waveform W at E, the fourth inductor 110-1d at D, the fifth inductor 110-1e at C, the sixth inductor 110-1f at C (and/or between C and D), the seventh inductor 110-1g at D (and/or between D and E), the eighth inductor 110-1h at E, the ninth inductor 110-1i at F, the tenth inductor 110-1j outside the waveform W, and the eleventh inductor 110-1k at E.

FIG. 6, image (2), shows a graphical representation of the energy received and potentially induced into corresponding currents by each of the inductors 100 described above. Given that the eleven inductors 100 in the first receiving channel 102 are in series, the energy from each waveform position may add and subtract in amplitude and phase and the resulting waveform may be provided to the ADC and DSP systems 200, 300 for processing (e.g., to provide additional effects, etc.).

It is understood that the second and third receiving channels 104, 106 also may be positioned to engage with the waveform W (e.g., in accordance to the arrangement of FIG. 5) to receive energy from the waveform W and to induce corresponding currents, all of which may be provided to the ADC and DSP systems 200, 300 for processing (e.g., to provide additional effects, etc.).

In some embodiments, the ADC system 200 may convert the analog induced current waveforms received from each independent receiving channel 102, 104, 106 into a digital representations of the same. The ADC system 200 also my include amplification elements (e.g., op-amps), frequency filters, and/or other elements as needed to perform its functionalities.

The converted digital individual digital waveforms from each receiving channel 102, 104, 106 may then be provided to the DSP system 300 for processing. In some embodiments, the DSP system 300 may process the digital signal(s) as is known in the art and may include a library of modular software components for providing and developing customizable audio applications (e.g., additional effects, etc.). In some embodiments, the DSP system 300 may include the DaisySP® open-source digital signal processing system.

In some embodiments, the converted signals from each of the receiving channels 102, 104, 106 may tend to better represent natural effects that a person may experience when listening to sound waves directly incident onto the person's eardrums combined with corresponding sound waves reflected, reverberated, and/or echoed from the environment. In some embodiments, the inventor has discovered that the first and second effects provided by the system 10 as described above may create a nuanced and less predictable overall effect on the received waveform W, as the physically offset placement of the receiving channels 102, 104, 106 and of the inductor elements 110 within each receiving channel 102, 104, 106 may allow for a variety of different portions of a magnetic field within the waveform W to be converted into corresponding analog signals (which may then be processed and output by the system 10).

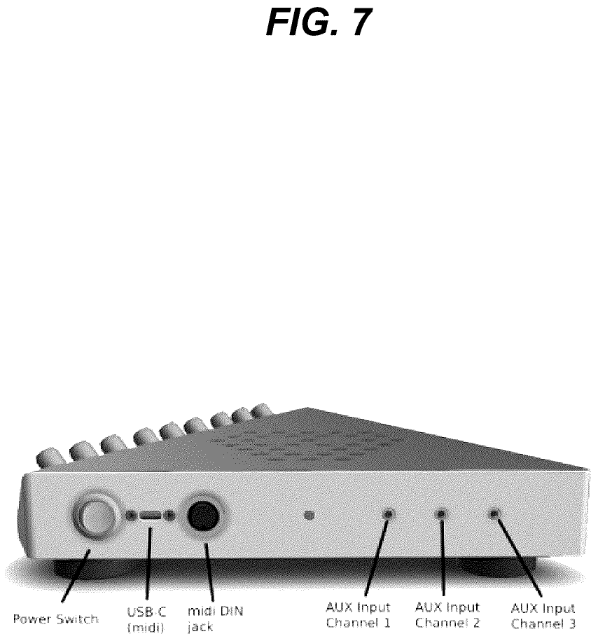

In some embodiments, as shown in FIG. 7, the system 10 (e.g., the signal input-output assembly 400) includes one or more auxiliary input channels that may receive respective auxiliary signals that may be mixed with the signals processed from the receiving channels 100. For example, in some embodiments, the system 10 may include three auxiliary signal inputs, one for each receiving channel 102, 104, 106. In some embodiments, the system 10 also may include one or more MIDI outputs, e.g., as USB-C and/or MIDI DIN connectors, etc. The system 10 also may include one or more speakers that may emit audio waves corresponding to the receiving channel 100 outputs, the auxiliary outputs, and/or the combinations thereof.

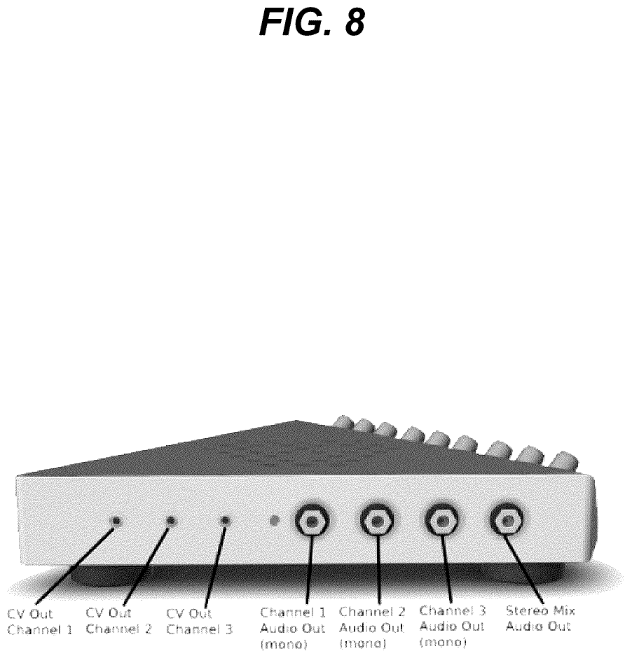

In addition, as shown in FIG. 8, the signal input-output assembly 400 includes one or more CV outputs (e.g., three CV outputs, one for each channel 102, 104, 106), one or more audio outputs (e.g., three audio outputs, one for each channel 102, 104, 106), and a stereo mix output that may provide a stereo mixed signal of the combined signals from the receiving channels 102, 104, 106.

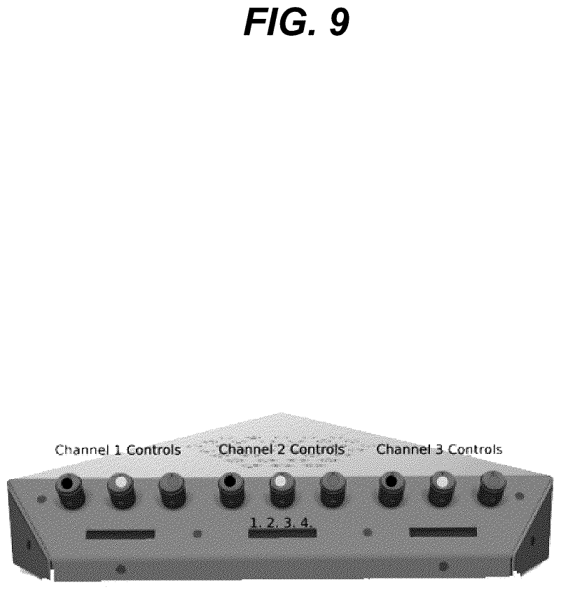

Also, as shown in FIG. 9, the system 10 may include a variety of control mechanisms (e.g., knobs, buttons, dials, touchscreen elements, etc.) to control the various aspects of the system 10. For example, system 10 may include volume controls for each of the channels 102, 104, 106, including volume controls for the inductor output(s) only, volume controls for a blend of the inductor outputs blended with the auxiliary inputs, and volume controls for the auxiliary inputs. While the control mechanisms have been described as generally manual mechanisms, it is understood that the system 10 may include an interface (hardwired, wireless, etc.) that may enable it to interface with an external controller of any kind (e.g., computer, smartphone, tablet computer, etc.) that may be used (e.g., via software) to provide control of the system 10.

In some embodiments, as shown in FIGS. 7, 8, and 9, the three receiving channels 102, 104, 106, the ADC and DSP systems 200, 300, the signal input-output assembly 400, and the other elements and/or components of the system 10 may be housed in a housing 500. In some embodiments, the housing 500 may generally be triangular to match the triangular arrangement of the receiving channels 102, 104, 106. In some embodiments, the top surface of the housing 500 may be formed as the surface that may be directed to the EMF signals that user may wish to sense and process.

It is understood that any aspect and/or element of any embodiment of the system 10 described herein or otherwise may be combined with any other aspect and/or element of any other embodiment described herein or otherwise in any way to form additional embodiments of the system 10 all of which are within the scope of the system 10.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs” and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to” and are not intended to exclude other components unless specifically so stated.

It will be appreciated that variations to the embodiments of the invention can be made while still falling within the scope of the invention. Alternative features serving the same, equivalent, or similar purpose can replace features disclosed in the specification, unless stated otherwise. Thus, unless stated otherwise, each feature disclosed represents one example of a generic series of equivalent or similar features.

The present invention also covers the exact terms, features, values, and ranges, etc. in case these terms, features, values, and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. An electromagnetic field receiver system comprising:
a first receiver channel including at least one first receiver element adapted to receive a first portion of an electromagnetic field (EMF) and to convert the first portion into a first current;
a second receiver channel including at least one second receiver element adapted to receive a second portion of the EMF and to convert the second portion into a second current;
an analog to digital converter (ADC) adapted to receive the first current and to convert the first current to a corresponding first digital signal, and to receive the second current and to convert the second current to a corresponding second digital signal; and
a digital signal processor (DSP) adapted to receive the first digital signal and the second digital signal and to apply at least one first effect to the first and second digital signals to form a first modified digital signal;
wherein the first receiver channel is positioned at a first unique physical orientation with respect to the second receiver channel.

2. The electromagnetic field receiver system of claim 1 wherein the at least one first effect includes combining the first and second digital signals.

3. The electromagnetic field receiver system of claim 2 wherein the combining of the first and second digital signals includes combining the first and second digital signals in amplitude and phase.

4. The electromagnetic field receiver system of claim 1 wherein the first modified digital signal is transformed into a first audio signal.

5. The electromagnetic field receiver system of claim 4 further comprising a speaker and wherein the first audio signal is provided to the speaker.

6. The electromagnetic field receiver system of claim 1 wherein the first receiver channel includes a first channel first leg, a first channel second leg, and a first channel third leg oriented to form a first triangular geometry.

7. The electromagnetic field receiver system of claim 6 wherein the second receiver channel includes a second channel first leg, a second channel second leg, and a second channel third leg oriented to form a second triangular geometry.

8. The electromagnetic field receiver system of claim 7 wherein the first triangular geometry is overlaid the second triangular geometry.

9. The electromagnetic field receiver system of claim 7 wherein the first triangular geometry is overlaid the second triangular geometry within a common plane.

10. The electromagnetic field receiver system of claim 8 further comprising:
a third receiver channel including at least one third receiver element adapted to receive a third portion of the EMF and to convert the third portion into a third current;
wherein the ADC is adapted to receive the third current and to convert the third current to a corresponding third digital signal; and
wherein the DSP is adapted to receive the third digital signal and to apply at least one second effect to the first, second and third digital signals to form a second modified digital signal;
wherein the third receiver channel is positioned at a second unique physical orientation with respect to the first and second receiver channels.

11. The electromagnetic field receiver system of claim 10 wherein the at least one second effect includes combining the first, second and third digital signals.

12. The electromagnetic field receiver system of claim 11 wherein the combining of the first, second and third digital signals includes combining the first, second and third digital signals in amplitude and phase.

13. The electromagnetic field receiver system of claim 10 wherein the second modified digital signal is transformed into a second audio signal.

14. The electromagnetic field receiver system of claim 13 further comprising a speaker and wherein the second audio signal is provided to the speaker.

15. The electromagnetic field receiver system of claim 10 wherein the third receiver channel includes a third channel first leg, a third channel second leg, and a third channel third leg oriented to form a third triangular geometry.

16. The electromagnetic field receiver system of claim 15 wherein the third triangular geometry is overlaid the first triangular geometry and the second triangular geometry.

17. The electromagnetic field receiver system of claim 16 wherein the third triangular geometry is overlaid the first triangular geometry and the second triangular geometry within a common plane.
